(19) United States
(12) Patent Application Publication
(10) Pub. No.: US 2023/0191713 A1
(43) Pub. Date: Jun. 22, 2023

(54) APPARATUS AND METHOD FOR RESISTIVE IMPLANT WELDING OF REINFORCED THERMOSETTING RESIN PIPE JOINTS IN A SINGLE STEP PROCESS

(71) Applicant: SAUDI ARABIAN OIL COMPANY, Dhahran (SA)

(72) Inventors: Chris Worrall, Cambridge (GB); Farshad Salamat-Zadeh, Cambridge (GB); Abderrazak Traidia, Lussan (FR); Anwar Parvez, Dhahran (SA)

(73) Assignees: SAUDI ARABIAN OIL COMPANY, Dhahran (SA); TWI Ltd., Cambridge (GB)

(21) Appl. No.: 17/645,206

(22) Filed: Dec. 20, 2021

(51) Int. Cl. B29C 65/34; F16L 47/03

(52) U.S. Cl. CPC B29C 65/3488; B29C 65/3452; B29C 65/3468; F16L 47/03; B29L 2031/24

(57) ABSTRACT

A system for coupling pipes includes a first pipe having a tapered, spigot end; a second pipe having a tapered, spigot end; a coupler having two tapered socket ends adapted to internally receive the respective tapered, spigot ends of the first pipe and the second pipe; and a resistive element. The first pipe, the second pipe, and the coupler are made from a reinforced thermosetting resin (RTR). The resistive element includes a first layer and a second layer of thermoplastic material; and an electrically conducting resistive heating element with positive and negative terminals for connecting electrical power. The electrically conducting resistive heating element is sandwiched by the first layer and the second layer of thermoplastic material. The resistive element is disposed between an interior of the coupler and at least one of: an exterior of the first pipe and an exterior of the second pipe. Upon application of electrical power to the positive and negative terminals of the resistive element, the electrically conducting resistive heating element generates heat sufficient to melt the thermoplastic material such that, when the heat is removed, the hardened thermoplastic material seals the first pipe and/or the second pipe to the coupler.

### BACKGROUND OF INVENTION

RTR (Reinforced Thermosetting Resin) pipe is an acronym given to a broad family of fiber reinforced thermosetting pipes manufactured via a filament winding process. The reinforcement is generally glass fiber and the resin (matrix) is a thermoset polymer, traditionally polyester, vinyl-ester, or epoxy depending on the nature of the transported fluids in the pipe and the service temperature. This has led to the development of 3 main product lines for RTR pipes; GRP (Glass Reinforced Polyester), GRV (Glass Reinforced Vinylester) and GRE (Glass Reinforced Epoxy) pipes.

RTR pipes are generally produced in rigid segments of about 10-12 meters in length and transported onsite before being eventually assembled (jointed) to each other to the required length. The historical development of RTR began with the need to replace heavy concrete and steel pipes used in utilities and potable/sewage water systems. However, the use of RTR pipes in higher value applications such as oil and gas (O&G) service (particularly GRE), has gained a great deal of attention and acceptance. Currently, thousands of kilometers of RTR pipes are installed globally (particularly in the Middle East region) on yearly basis to meet the need of critical applications such as high pressure water injection and sour crude oil flowlines. The experience of O&G operators over the last decades has shown that RTR is a mature technology and can be an economical alternative to traditional carbon steel pipes, particularly in view of the fact that RTR pipe is not subject to the same corrosion seen in carbon steel piping. Depending on the manufacturer’s product portfolio, RTR line pipes are generally available in diameters ranging from 1½″ to 44″ and can be designed to handle pressures ranging from 150 psi to 4000 psi and temperatures up to 210° F.

Within the RTR pipe manufacturing industry is well-known that the joint/connection in an RTR pipeline system is often the limiting component towards a higher temperature and pressure operating envelope. The envelope is often defined in terms of the product pressure in view of the diameter (i.e., larger diameter RTR pipe generally cannot handle the same pressure as smaller diameter piping). Indeed, the experience of O&G operators has shown that most failures/leaks in RTR pipe systems are associated with joint failures. This could potentially reduce the confidence in the material and technology.

A number of proprietary joint designs have been developed over the years by the manufacturers, which can generally be grouped into two main types/categories; adhesive/bonded joints and interference joints. The former, adhesive/bonded joints, relies on an adhesive (or a laminate in case of wrapped/laminated joints) to transfer the load from one pipe to another and the performance/limitation of such joints is often associated with proper surface preparation, particularly in field conditions. The latter, interference joints, relies on a solid contact and direct load transfer between the two RTR pipes to be jointed, such as threaded and key-lock joints. A combination of both techniques (i.e, adhesive and interference) is also possible (e.g., the Injected Mechanical Joint - IMJ).

In general, high-pressure RTR pipes make use of interference or mechanical joints (threaded or key-lock joints), while lower pressure ratings can be achieved with adhesive and laminate joints. Examples of interference joints are shown in FIG. 1A, which shows an integral threaded joint, FIG. 1B, which shows a coupled threaded joint, and FIG. 2, which shows a key-lock joint. Referring to FIG. 1A, the joint 100 is formed between a first RTR pipe 102 having a threaded spigot end and a second RTR pipe 104 having a threaded socket end. Referring to FIG. 1B, joint 110 is formed between a first RTR pipe 112 having a threaded spigot end and a second RTR pipe 114 also having a threaded spigot end by employing a coupler pipe 116 having threaded socket ends. Referring to FIG. 2, joint 200 is formed between an RTR pipe 202 having a spigot end and an RTR pipe 204 having a socket end using locking strips 206 and a rubber sealing (O-ring) 208.

### SUMMARY OF INVENTION

In one aspect, one or more embodiments relate to a system for coupling pipes comprising: a first pipe having a tapered, spigot end; a second pipe having a tapered, spigot end; a coupler having two tapered socket ends adapted to internally receive the respective tapered, spigot ends of the first pipe and the second pipe, wherein the first pipe, the second pipe, and the coupler are made from a reinforced thermosetting resin (RTR), and a resistive element comprising: a first layer and a second layer of thermoplastic material; and an electrically conducting resistive heating element with positive and negative terminals for connecting electrical power, wherein the electrically conducting resistive heating element is sandwiched by the first layer and the second layer of thermoplastic material, wherein the resistive element is disposed between an interior of the coupler and at least one of: an exterior of the first pipe and an exterior of the second pipe, and, wherein, upon application of electrical power to the positive and negative terminals of the resistive element, the electrically conducting resistive heating element generates heat sufficient to melt the thermoplastic material such that, when the heat is removed, the hardened thermoplastic material seals the first pipe and/or the second pipe to the coupler.

In one aspect, one or more embodiments relate to a system for coupling pipes comprising: a first pipe having a tapered, spigot end; a second pipe having a tapered, socket end adapted to internally receive the tapered, spigot end of the first pipe; wherein the first pipe and the second pipe are made from a reinforced thermosetting resin (RTR), and a resistive element comprising: a first layer and a second layer of thermoplastic material; and an electrically conducting resistive heating element with positive and negative terminals for connecting electrical power, wherein the electrically conducting resistive heating element is sandwiched by the first layer and the second layer of thermoplastic material, wherein the resistive element is disposed between an exterior of the first pipe and an interior of the second pipe, wherein, upon application of electrical power to the positive and negative terminals of the resistive element, the electrically conducting resistive heating element generates heat sufficient to melt the thermoplastic material such that, when the heat is removed, the hardened thermoplastic material seals the first pipe to the second pipe.

In one aspect, one or more embodiments relate to a method of coupling a first pipe and a second pipe to a coupler, wherein the first pipe, the second pipe, and the coupler are made from a reinforced thermosetting resin (RTR), wherein the first pipe and the second pipe respectively have a tapered, spigot end, wherein the coupler has a tapered socket ends adapted to internally receive the tapered, spigot ends of the first pipe and the second pipe, the method comprising: disposing a resistive element between an exterior of the first pipe, an exterior of the second pipe, and an interior of the coupler, wherein the resistive element comprises a first thermoplastic layer; a second thermoplastic layer, and an electrically conducting resistive heating element with positive and negative terminals for connecting electrical power, and wherein the electrically conducting resistive heating element is sandwiched by the first layer and the second layer of thermoplastic material; inserting the first pipe and the second pipe into respective ends of the coupler; and applying electrical power to the resistive element to cause the electrically conducting resistive heating element to generate heat sufficient to melt the thermoplastic material such that, when the heat is removed, the hardened thermoplastic material seals the first pipe and the second pipe to the coupler.

In one aspect, one or more embodiments relate to a method of coupling a first pipe and a second pipe, wherein the first pipe and the second pipe are made from a reinforced thermosetting resin (RTR), wherein the first pipe has a tapered, spigot end, wherein the second pipe has a tapered socket ends adapted to internally receive the tapered, spigot ends of the first pipe, the method comprising: disposing a resistive element between an exterior of the first pipe and an interior of the second pipe, wherein the resistive element comprises a first thermoplastic layer; a second thermoplastic layer, and an electrically conducting resistive heating element with positive and negative terminals for connecting electrical power, and wherein the electrically conducting resistive heating element is sandwiched by the first layer and the second layer of thermoplastic material, inserting the first pipe into the second pipe; and applying electrical power to the resistive element to cause the electrically conducting resistive heating element to generate heat sufficient to melt the thermoplastic material such that, when the heat is removed, the hardened thermoplastic material seals the first pipe to the second pipe.

Other aspects and advantages of the invention will be apparent from the following description and the appended claims.

### BRIEF DESCRIPTION OF DRAWINGS

FIGS. 1A and 1B show an integral and a coupled threaded joint, respectively.

FIG. 2 shows a key-lock joint.

FIG. 3 shows a schematic representation of overloading failure of threaded RTR connections.

FIG. 4 is a schematic cross-section representation of an electrofusion RTR joint making use of a thermoplastic tie layer on the pipe and coupler ends.

FIGS. 5A-5C are schematic 3D representations of the resistive element in accordance with one or more embodiments of the invention.

FIGS. 6A and 6B are schematic representations of the copper coated PEEK film, in FIG. 6A, before and, in FIG. 6B, after etching the required heating element pattern in accordance with one or more embodiments of the invention.

FIGS. 7A and 7B are schematic representations, 3D representation in FIG. 7A and cross-section representation in FIG. 7B, of a cylindrical resistive element with multiple (alternating) heating and tie layers in accordance with one or more embodiments of the invention.

FIG. 8 is a schematic cross-section representation of the full RTR joint system when used as an integral joint in accordance with one or more embodiments of the invention.

FIG. 9 is a schematic cross-section representation of the full RTR joint system when used as a coupler joint in accordance with one or more embodiments of the invention.

FIG. 10 is a schematic cross-section representation of the electrically resistive implant with a full NM structure and carbon reinforced PEEK strip in accordance with one or more embodiments of the invention.

FIGS. 11A, 11B, and 11C are schematic 3D representations of the single step resistive implant joining process: FIG. 11A abrasion of faying surfaces, FIG. 11B resistive element insertion and assembly, FIG. 11C connection to power supply, heating and joining.

FIG. 12 is a chart showing a resistive implant weld cycle (typical) with multi-stage heating profile program.

FIG. 13 is a flow chart illustrating steps included in a method in accordance with one or more embodiments of the invention.

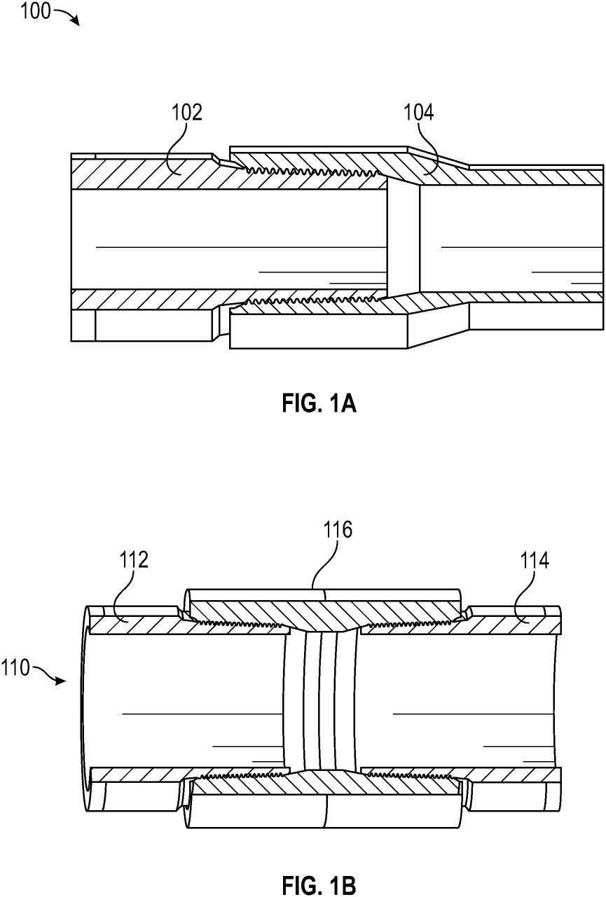

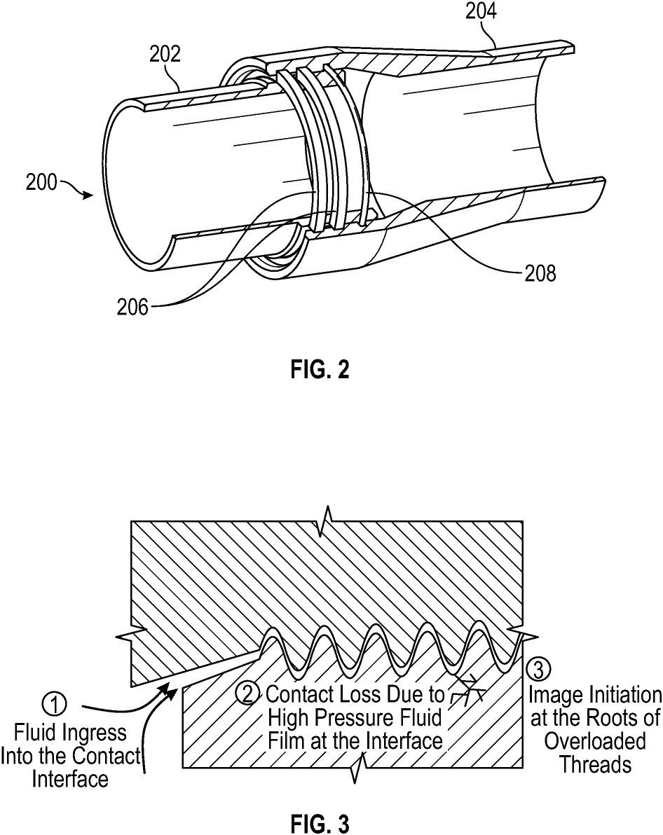

### DETAILED DESCRIPTION

Threaded joints are traditionally used for high pressure RTR pipes. These can be either “integral” (i.e., a connection that does not use a joining member/coupler to transfer the load from one pipe to the other) or using a “coupler.” Although threaded joints can achieve outstanding performance, in terms pressure rating and sealing capacity, the experience of O&G operators has shown that failures can happen. The general opinion is that the failures are associated with improper installation by the jointers (pipe misalignment, over-torqueing, improper/insufficient taping of the thread compound -TEFLON® (a trademark of the The Chemours Company FC, LLC), etc.).

A typical failure mechanism is illustrated in FIG. 3. A poor installation can result in imperfections/cavities along the contact surface between the spigot and the socket. In operation, fluid (e.g., water) at high pressure and high temperature could ingress into these cavities (step #1) and create a high pressure fluid film (step #2) which would slowly propagate along the spigot-socket interface. In some cases, the creep of the resin at the interface can aggravate the water propagation at the interface. As the ingress progresses, the contact pressure on the initial threads is eliminated and the excess load is transferred to the nearby threads, which eventually leads to overloading failure (step #3).

One or more embodiments of the present invention introduce a new jointing technique that will reduce, and potentially eliminate, failures and increase the confidence in the RTR pipe technology. The ultimate target for such embodiments is to replace current jointing technologies for RTR pipes (low and high pressure) with a maximum operating envelope up to 24″ at 1500 psi pressure rating and service temperatures above 200° F.

Therefore, one or more embodiments of the present invention relate to a system and method for advanced coupling and sealing of reinforced thermosetting resin (RTR) pipes in a single step process, with or without the need for abrasive surface preparation. The system comprises: (1) a first RTR pipe with tapered spigot end with faying surfaces prepared using either mechanical abrasion or simple solvent wiping, (2) a second RTR pipe or RTR coupler with tapered socket end having a similar surface preparation, and (3) a “weldable” resistive element comprising at least a thermoplastic material and an electrically conductive component. The jointing method involves a simple assembly of the different system components followed by connecting the resistive element electrodes to an external power supply to generate, by the Joule effect, the heat required to melt the thermoplastic layer and form a thermally activated joint between the RTR pipes and coupler.

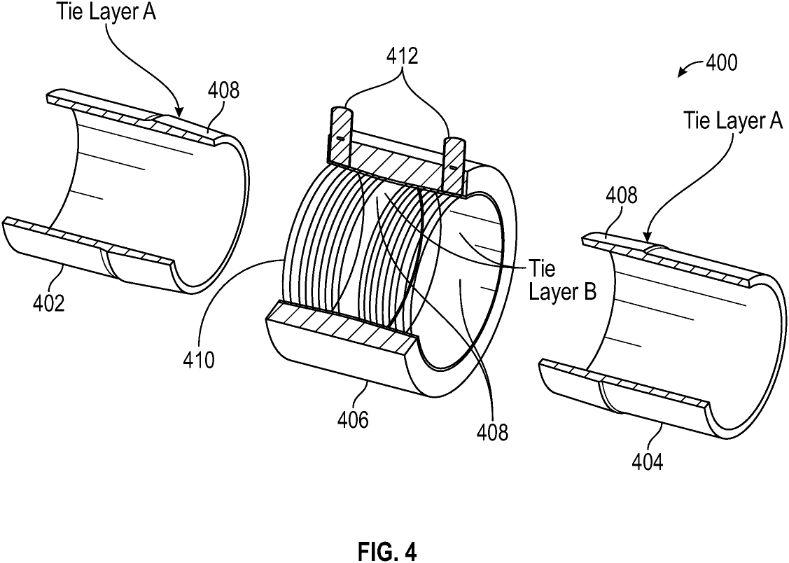

FIG. 4 is a schematic cross-section representation of an electrofusion Reinforced Thermosetting Resin (RTR) joint making use of a thermoplastic tie layer on the pipe and coupler ends. As can be seen, a joint 400 is being formed between a first RTR pipe 402 with a tapered spigot portion (end) coated with a tie layer comprising at least a thermoplastic material (tie layer A) 408 and a second RTR pipe with a tapered spigot portion (end) coated with a tie layer comprising at least a thermoplastic material (tie layer A) 408 by employing a reinforced thermoset (RTR) coupler pipe 406 with a tapered socket portions (ends) coated with a tie layer comprising at least a thermoplastic material (tie layer B) 408 and incorporating resistive implant elements (such as metallic coils, sheet, meshes, etc.) 410. The resistive implant elements 410 are connected to electrodes 412, which extend from the coupler pipe 406.

In previous disclosures by the present inventors, the details of jointing and sealing concepts (apparatus and methods) have been described for RTR pipes using a variety of thermal welding techniques. Those techniques rely primarily on adding a “welding” functionality to the RTR pipes (known to be non-weldable) using a thermoplastic interlayer deposited on the faying surfaces of the to-be-jointed RTR pipes. More specifically, a thermoplastic layer (which may include metallic susceptors, if needed) is bonded to the pipe and coupler ends, which should preferably done at the pipe manufacturing stage. At the installation site, the functionalised pipes and coupler are pushed into each other and subsequently jointed by applying sufficient heat (e.g., by induction, friction, or resistive welding process) to melt and fuse the thermoplastic layers to each other. Upon cooling, a fully bonded and sealed joint is formed.

In the above process, two heating steps are required: one to deposit the thermoplastic interlayer onto the RTR laminate and a second to melt the interlayer and form the sealed joint. Accordingly, in one or more embodiments of the present invention, welded RTR pipe configuration(s) are created in a single step without relying on prerequisite deposition of the thermoplastic tie layer. In one or more embodiments, there may still need to be a preparatory surface abrasion process, if sufficient joint performance cannot be achieved by simple solvent wiping to clean the faying surfaces prior to joining. The single stage joining process is facilitated through the use of a separate resistive component that combines an electrically conducting element encapsulated inside a thermoplastic material; this component being inserted between the to-be-jointed RTR pipes and/or coupler ready for joining.

One or more embodiments relate to a specific structure of a thermoplastic-based resistive element, in the form of a sleeve, that can be used to bond RTR laminates, such as, glass fiber reinforced epoxy (“GRE”), via thermal welding processes through the sleeve’s action as an intermediate thermoplastic tie layer. The sleeve may replace the adhesives traditionally used to assemble RTR pipes and structures, which have shown a dependence on surface preparation. One or more embodiments relate to a full system including the resistive element in an integral (i.e., no coupler) RTR joint or a coupler RTR joint. One or more embodiments relate to a methodology for assembling and welding the RTR joint(s). It is worth noting that the present disclosure shows PEEK as a thermoplastic material, however, other thermoplastic materials traditionally used in the oil and gas industry (PE, PVDF, PPS, PAEK, PA, etc,) may also be used.

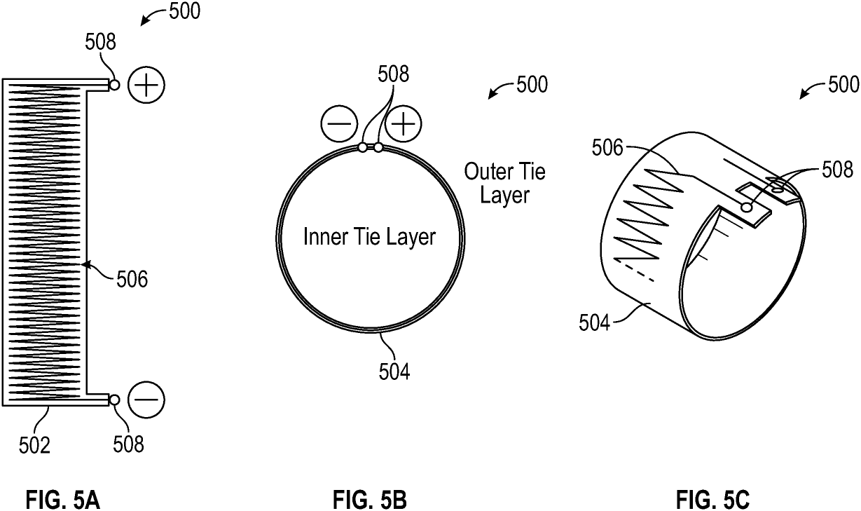

A schematic representation of the resistive element 500 is shown in FIGS. 5A, 5B, and 5C. As can be seen, the resistive element 500 is made of a thermoplastic material, e.g., PEEK, that constitutes an inner tie layer and outer tie layer, and may take the form of a strip 502, as shown in FIG. 5A, or a sleeve 504, as shown in FIGS. 5B-5C. Whether the resistive element 500 is formed in a strip 502 or a sleeve 504, the resistive element 500 contains an electrically conducting resistive heating element 506 with positive and negative terminals 508 for connecting electrical power.

The resistive element 500 performs a similar function as both the thermoplastic tie layer and the electrofusion heating element as the previously disclosed process. Here, the two functions are combined into a single element that can be employed to join pipes in a single step. In one or more embodiments, the strip 502 or the sleeve 504 comprises at least three layers: a thermoplastic inner layer (inner tie layer), a thermoplastic outer layer (outer tie layer), and an electrically conducting resistive heating element sandwiched between the inner and outer layers. In one or more embodiments, three or more layers are consolidated, or semi-consolidated, prior to the joining operation to facilitate assembly in the joint.

In one or more embodiments, the thermoplastic inner element (inner tie layer) comprises a thermoplastic that is used to act as both a joining and a sealing component. As discussed above, PEEK is used as an example due to having a high temperature stability and chemical resistance. However, other thermoplastics could be used depending on the application, as well as the required mechanical and sealing performance of the resulting joint. The thermoplastic outer element (outer tie layer) serves the same purpose as the inner tie layer and, in one or more embodiments, may be made in a similar manner and of similar materials. In one or more embodiments, the inner tie layer and outer tie layer may be made from compatible polymer materials.

The electrically conducting resistive heating element is used to supply the heat required to melt the inner and outer thermoplastic layers so as to form the joint. The element can be any electrically conducting material that has sufficient resistivity to generate heating through the Joule heating mechanism. Suitable element materials include copper wires or braids, stainless steel and carbon fibers, all of which are currently in use in a number of applications as resistive elements for thermoplastic and thermoplastic composite welding. In one or more embodiments, the form of the element may be any number of different patterns, designed in order to achieve uniform heating.

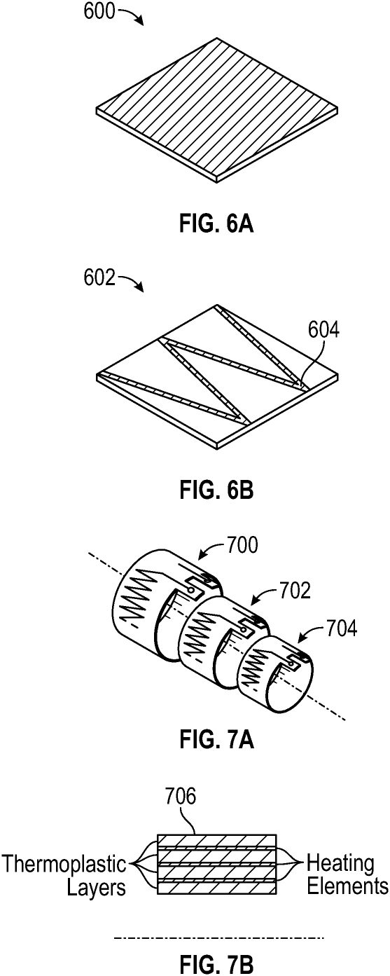

In one or more embodiments, the electrically conducting resistive heating element may be a separate component or integrated (e.g., printed or etched) into one of the inner/outer tie layer elements using metallic coated polymer films such as the copper coated PEEK film shown in FIGS. 6A and 6B. As can be seen, in one or more embodiments, a copper-coated PEEK film 600 may be obtained and, after etching, the resulting article is an etched PEEK film 602 contain a copper heating element pattern 604.

In cases where a thick overall thermoplastic joining layer is required, it may be desirable for multiple tie layers and resistive heating elements to be incorporated together, as is schematically illustrated in FIGS. 7A and 7B. As can be seen, sleeves 700, 702, and 704 are nested together, as shown in FIG. 7A, so as to form the layered structure 706 shown in FIG. 7B. The resulting layered structure 706 includes multiple, alternating heating and tie layers. This approach ensures more control over the heat profile through the thickness of the element, which may be particularly important when using semi-crystalline polymers (e.g., PEEK) where control of crystallinity may be important.

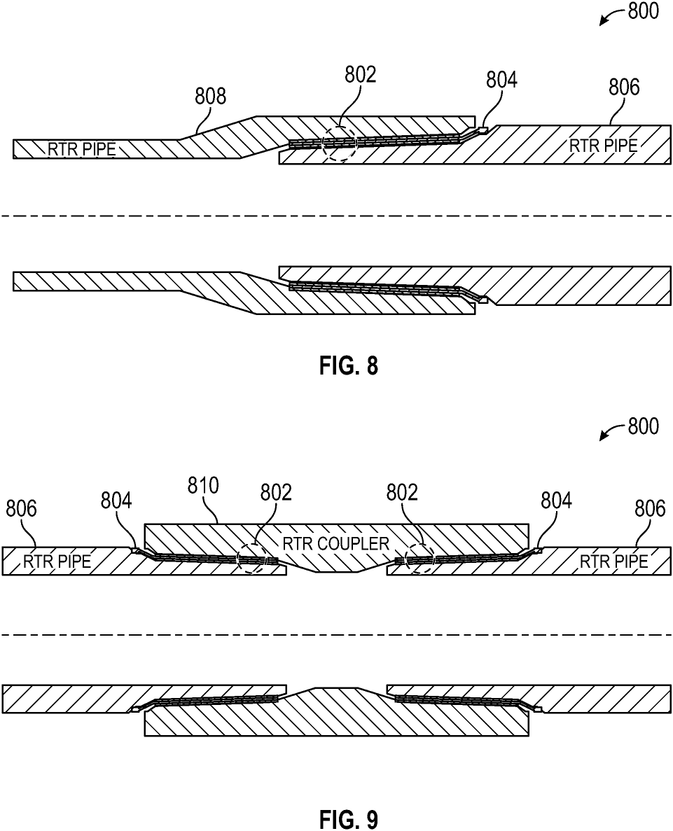

Referring to FIGS. 8-9, a schematic of systems in accordance with one or more embodiments are shown. In the RTR jointing system 800, the resistive element 802 can be used in multiple ways to join and seal RTR pipes together once power has been connected to electrodes 804. There are two main configurations in which the RTR jointing system 800 can be used: (1) a configuration to produce an integral RTR joint or (2) a configuration to produce a coupler RTR joint.

In the first configuration, i.e., an integral RTR joint as shown in FIG. 8, the RTR jointing system 800 is used to connect a first RTR pipe 806 having a tapered spigot end and a second RTR pipe 808 having a tapered socket end. The resistive element 802 is placed between the two ends of the first RTR pipe 806 and the second RTR pipe 808 such that the electrodes 804 are exposed. If made in the form of a strip, then the resistive element 802 can be wrapped around the first RTR pipe end 806 before insertion into the second RTR pipe 808. However, if made in the form of a sleeve, then the resistive element 802 would need to be selected such that the dimensions, i.e., inner diameter (ID), outer diameter (OD), and taper angle, properly match the dimensions of the ends of the first RTR pipe 806 and the second RTR pipe 808. Once installed, power is connected to the electrodes 804 so as to cause heating that joins and seals the RTR pipes 806, 808 together.

In the second configuration, i.e., a coupler RTR joint as shown in FIG. 9, an RTR coupler 810 is used in between two RTR pipes 806 having tapered spigot ends and the resistive elements 802 are placed between the respective ends of the RTR pipes 806 and the RTR coupler 810 such that the electrodes 804 are exposed. In one or more embodiments, a single resistive element 802 could be used, if selected such that the resistive element 802 extended across the full inner length of the RTR coupler 810. Once installed, power is connected to the electrodes 804 so as to cause heating that joins and seals the RTR pipes 806 and the RTR coupler 810 together.

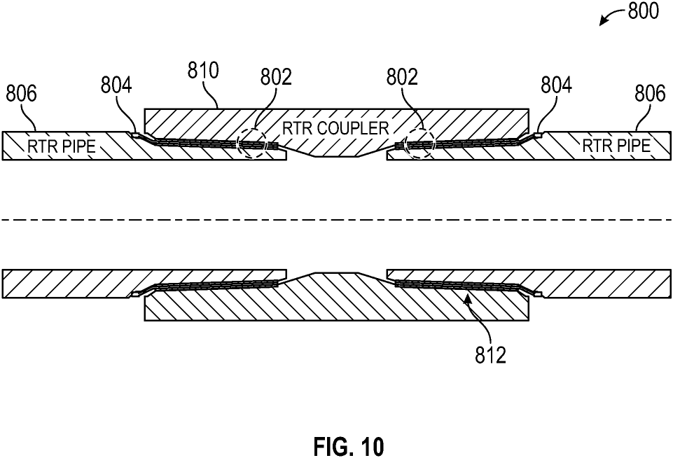

Referring to FIG. 10, in one or more embodiments, a carbon-reinforced PEEK strip implant 812, or other material with a full NM structure, is implanted in the connection. Thus, the welding process can be accomplished without the need of metallic mesh and yields several benefits. First, metallic material utilization is eliminated completely. The use of a unidirectional carbon fiber in a PEEK matrix provides higher hoop strength in the resulting coupling due to having a higher strength to weight ratio. One example includes a continuous carbon fiber reinforced strip, where the fibers are all aligned in the hoop direction of the pipe. The fibers would not only reinforced the strip (i.e., the thermoplastic tie layer) but also, would provide an electrical path for the electric current during the heating/welding process.

Also, NDT (non-destructive testing) technique utilization is facilitated to assess welding integrity. That is, post welding, the electrical conductivity still exists and, therefore, can be used as means of NDT inspection, e.g., using electrical tomography, where the mean electrical resistivity of the joint can be correlated to some damage or liquid uptake in the joint. Such information may also be used to quantify the “tightness/sealability” of the joint while in operation via an electrical resistivity measurement.

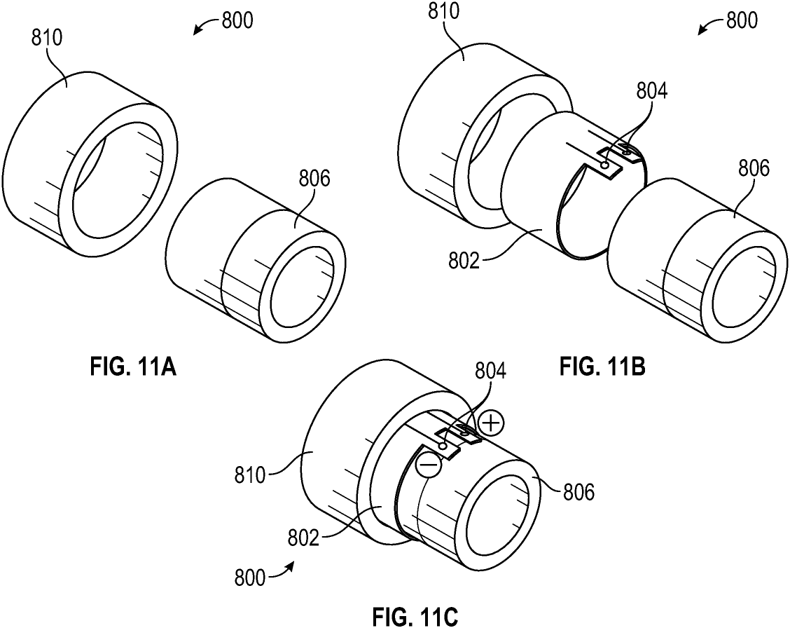

Referring to FIGS. 11A-C, a method in accordance with one or more embodiments is described. The elements of RTR jointing system 800 including the resistive element 802 of thermoplastic material containing an electrically conducting resistive heating element with exposed electrodes 804 being placed between the respective ends of the RTR pipes 806 and the RTR coupler 810 is similar to the earlier description. Thus, the reference numbers are maintained and the description is not repeated here.

First, as can be seen in FIG. 11A, the faying surfaces of the ends of the RTR pipe 806 and/or RTR coupler 810 are prepared using a suitable process, such as sand/grit blasting. Care should be taken not to cause damage to the fibers in the RTR structure while doing so. The surfaces are then cleaned to remove dust and debris. With suitable joint design, it may not be necessary to carry out the abrasion process and, instead, a solvent wipe process may be sufficient to create a clean joining surface.

As can be seen in FIG. 11B, the selected resistive element 802 is then inserted, if made in the form of a sleeve as shown (or, in the case of a resistive element made in the form of a strip, wrapped) into the joint between the RTR pipe 806 and RTR coupler 810 components. Then, as can be seen in FIG. 11C, the joint is assembled such that the electrodes 804 are exposed. When the pipes are mated, it is important to ensure close contact between the resistive element 802 with the respective ends of RTR pipe 806 and RTR coupler 810. Those skilled in the art will appreciate that such an operation can be achieved using conventional pulling equipment already in use in the field. As previously discussed, in certain coupler joint situations, it may be preferable to use two resistive elements 802, with one on either side of the coupler, or it may be preferable to use a single resistive element 802 that traverses the entire inner length of the coupler 810 to reach the ends of both pipes 806.

Once correctly assembled, power (shown as negative and positive in FIG. 11C) is supplied by connecting a power supply (not shown) to the electrodes 804 of the resistive heating element 802. In one or more embodiments, the power supply may comprise a direct current (DC) or alternating current (AC), which, for example, may be a pulsed-AC electrical power source driven by a diesel generator. For typical joining applications, on joint areas encountered in pipes of up to 24″ (inches) in diameter, a power supply of 30 kW (kilowatts) provides sufficient electrical energy.

During the heating stage, the thermoplastic material will melt, allowing the pipes to be pushed/pulled closer together, causing flow of the polymer, wetting of the entire faying surfaces, and creating a more efficient joint, both in terms of structural integrity and sealing. The angle of the taper and the total length of the overlap are important factors in determining the required pressure rating and sealing capacity. Additionally, in one or more embodiments, by adding an external push/pull (i.e., axial force) during the make-up of the connection, close contact of the pipes with the tie layer is maintained and, therefore, a stronger joint is achieved.

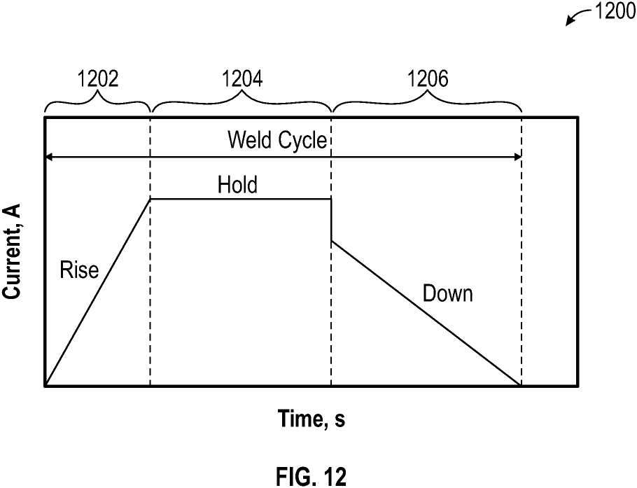

After the predetermined heating time the power is switched off. If a specific cooling profile is required in order to control the crystallinity in the thermoplastic layer, then the power can be reduced gradually. In certain situations, it may also be beneficial to carry out a multi-stage heating profile comprising multiple welding cycles. As can be seen in FIG. 12, a typical welding cycle 1200 includes a rise phase 1202, hold phase 1204, and down phase 1206. In one or more embodiments, the multi-stage, cycle heating profiles may be optimized for each joint configuration and programmed into the power supply unit.

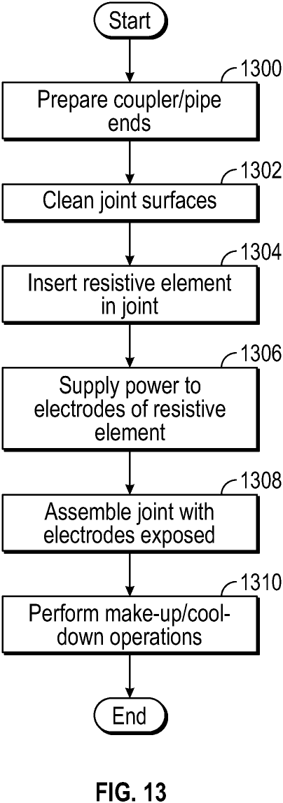

Referring to FIG. 13, a flow chart illustrating steps included in a method in accordance with one or more embodiments is shown.

First, the faying surfaces of the ends of the RTR pipe 806 and/or the RTR coupler 810 are prepared using a suitable abrasion process, such as sand/grit blasting, or a solvent wipe process (Step 1300). The surfaces are then cleaned to remove dust and debris (Step 1302). The resistive element 802 is then inserted into the joint (Step 1304) and the joint is assembled such that the electrodes 804 are exposed (Step 1306). Once correctly assembled, power is supplied to the electrodes 804 of the resistive element 802 to begin heating (Step 1308). During the heating stage, make-up and/or cool-down operations, such as pushing/pulling the joint closer together while the thermoplastic material melts, conducting multiple heating cycles, reducing power gradually, and the like, may be performed (Step 1310).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for coupling pipes comprising:
a first pipe having a tapered, spigot end;
a second pipe having a tapered, spigot end;
a coupler having two tapered socket ends adapted to internally receive the respective tapered, spigot ends of the first pipe and the second pipe,
wherein the first pipe, the second pipe, and the coupler are made from a reinforced thermosetting resin (RTR), and
a resistive element comprising:
a first layer and a second layer of thermoplastic material; and
an electrically conducting resistive heating element with positive and negative terminals for connecting electrical power,
wherein the electrically conducting resistive heating element is sandwiched by the first layer and the second layer of thermoplastic material,
wherein the resistive element is disposed between an interior of the coupler and at least one of: an exterior of the first pipe and an exterior of the second pipe, and,
wherein, upon application of electrical power to the positive and negative terminals of the resistive element, the electrically conducting resistive heating element generates heat sufficient to melt the thermoplastic material such that, when the heat is removed, the hardened thermoplastic material seals the first pipe and/or the second pipe to the coupler.

2. The system of claim 1, wherein the resistive element is a sleeve, and wherein a diameter of the resistive sleeve element is matched to a diameter of the first pipe, the second pipe, and the coupler.

3. The system of claim 1, further comprising a plurality of resistive elements,
wherein at least one of the plurality of resistive elements is disposed between an exterior of the first pipe and an interior of the coupler,
wherein the resistive element is disposed between an exterior of the second pipe and an interior of the coupler, and
wherein, upon application of electrical power to the respective positive and negative terminals of each of the plurality of resistive elements, the respective electrically conducting resistive heating elements generate heat sufficient to melt the thermoplastic material such that, when the heat is removed, the hardened thermoplastic material seals the first pipe and the second pipe to the coupler.

4. The system of claim 1, wherein the resistive element is disposed along an entirety of an interior of the coupler,
wherein, upon insertion of the first pipe into the coupler, the resistive element is disposed between an exterior of the first pipe and the interior of the coupler,
wherein, upon insertion of the second pipe into the coupler, the resistive element is disposed between an exterior of the second pipe and the interior of the coupler,
wherein, upon application of electrical power to the positive and negative terminals of the resistive element, the electrically conducting resistive heating element heats the coupler, the first pipe, and the second pipe, sufficiently to melt the thermoplastic material such that, when the heat is removed, the hardened thermoplastic material seals the first pipe and the second pipe to the coupler.

5. The system of claim 1, wherein the resistive element comprises a plurality of electrically conducting resistive heating elements each sandwiched between a first layer and a second layer of thermoplastic material.

6. A system for coupling pipes comprising:
a first pipe having a tapered, spigot end;
a second pipe having a tapered, socket end adapted to internally receive the tapered, spigot end of the first pipe;
wherein the first pipe and the second pipe are made from a reinforced thermosetting resin (RTR), and
a resistive element comprising:
a first layer and a second layer of thermoplastic material; and
an electrically conducting resistive heating element with positive and negative terminals for connecting electrical power,
wherein the electrically conducting resistive heating element is sandwiched by the first layer and the second layer of thermoplastic material,
wherein the resistive element is disposed between an exterior of the first pipe and an interior of the second pipe,
wherein, upon application of electrical power to the positive and negative terminals of the resistive element, the electrically conducting resistive heating element generates heat sufficient to melt the thermoplastic material such that, when the heat is removed, the hardened thermoplastic material seals the first pipe to the second pipe.

7. The system of claim 6, wherein the resistive element is a sleeve, and wherein a diameter of the resistive sleeve element is matched to a diameter of the first pipe, the second pipe, and the coupler.

8. The system of claim 6, wherein the resistive element comprises a plurality of electrically conducting resistive heating elements each sandwiched between a first layer and a second layer of thermoplastic material.

9. A method of coupling a first pipe and a second pipe to a coupler, wherein the first pipe, the second pipe, and the coupler are made from a reinforced thermosetting resin (RTR), wherein the first pipe and the second pipe respectively have a tapered, spigot end, wherein the coupler has a tapered socket ends adapted to internally receive the tapered, spigot ends of the first pipe and the second pipe, the method comprising:
disposing a resistive element between an exterior of the first pipe, an exterior of the second pipe, and an interior of the coupler, wherein the resistive element comprises a first thermoplastic layer; a second thermoplastic layer, and an electrically conducting resistive heating element with positive and negative terminals for connecting electrical power, and wherein the electrically conducting resistive heating element is sandwiched by the first layer and the second layer of thermoplastic material;
inserting the first pipe and the second pipe into respective ends of the coupler; and
applying electrical power to the resistive element to cause the electrically conducting resistive heating element to generate heat sufficient to melt the thermoplastic material such that, when the heat is removed, the hardened thermoplastic material seals the first pipe and the second pipe to the coupler.

10. The method of claim 9, wherein the resistive element is a strip, the method further comprising: wrapping the strip around the exterior of the respective ends of the first pipe and the second pipe prior to insertion into the coupler.

11. The method of claim 9, wherein the resistive element is a sleeve, the method further comprising: matching a diameter of the resistive sleeve element is matched to a diameter of the first pipe, the second pipe, and the coupler.

12. The method of claim 11 further comprising: performing make-up operations during the applying of electrical power to the resistive element.

13. The method of claim 11 further comprising: performing cool-down operations during the applying of electrical power to the resistive element.

14. The method of claim 11 further comprising: performing an electrical resistivity measurement using the resistive element.

15. A method of coupling a first pipe and a second pipe, wherein the first pipe and the second pipe are made from a reinforced thermosetting resin (RTR), wherein the first pipe has a tapered, spigot end, wherein the second pipe has a tapered socket ends adapted to internally receive the tapered, spigot ends of the first pipe, the method comprising:
disposing a resistive element between an exterior of the first pipe and an interior of the second pipe, wherein the resistive element comprises a first thermoplastic layer; a second thermoplastic layer, and an electrically conducting resistive heating element with positive and negative terminals for connecting electrical power, and wherein the electrically conducting resistive heating element is sandwiched by the first layer and the second layer of thermoplastic material,
inserting the first pipe into the second pipe; and
applying electrical power to the resistive element to cause the electrically conducting resistive heating element to generate heat sufficient to melt the thermoplastic material such that, when the heat is removed, the hardened thermoplastic material seals the first pipe to the second pipe.

16. The method of claim 15, wherein the resistive element is a strip, the method further comprising: wrapping the strip around the exterior of the respective ends of the first pipe and the second pipe prior to insertion into the coupler.

17. The method of claim 15, wherein the resistive element is a sleeve, the method further comprising: matching a diameter of the resistive sleeve element is matched to a diameter of the first pipe, the second pipe, and the coupler.

18. The method of claim 15 further comprising: performing make-up operations during the applying of electrical power to the resistive element.

19. The method of claim 15 further comprising: performing cool-down operations during the applying of electrical power to the resistive element.

20. The method of claim 15 further comprising: performing an electrical resistivity measurement using the resistive element.
